(19) United States
(12) Patent Application Publication
(10) Pub. No.: US 2006/0155577 A1
(43) Pub. Date: Jul. 13, 2006

(54) System and method for anatomically based processing of medical imaging information

(75) Inventor: Tanya Niemeyer, Seattle, WA (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: Confirma, Inc., Kirkland, WA (US)

(21) Appl. No.: 11/031,303

(22) Filed: Jan. 7, 2005

(51) Int. Cl. G06Q 10/00

(52) U.S. Cl. 705/2

(57) ABSTRACT

One anatomically based medical information processing procedure involves acquiring one or more medical imaging data sets, and dividing and/or merging particular medical imaging data sets to form one or more anatomically based data sets. An anatomically based data set may comprise medical imaging data corresponding to an anatomical region that subsumes or is subsumed by an anatomical region corresponding to a medical imaging data set used to generate the anatomically based data set. Different medical imaging data sets and/or anatomically based data sets may correspond to different anatomical regions and/or imaging modalities. Display of one or more acquired medical imaging data sets and/or anatomically based data sets may be facilitated through a GUI, which may include a menu organized by anatomical region.

### TECHNICAL FIELD

The present disclosure relates generally to medical imaging techniques. More particularly, the present disclosure describes a system and/or method for processing medical information corresponding to one or more imaging modalities based upon anatomical considerations.

### BACKGROUND

Medical imaging technologies can provide detailed information useful for differentiating, diagnosing, or monitoring the condition, structure, and/or extent of various types of tissue within a patient's body. In general, medical imaging technologies detect and record manners in which tissues respond to the presence of applied signals and/or injected or ingested substances, and generate visual representations indicative of such responses.

A variety of medical imaging modalities exist, including Computed Tomography (CT), Positron Emission Tomography (PET), Single Photon Emission Computed Tomography (SPECT), Ultrasound (US), X-ray, Mammography, and Magnetic Resonance Imaging (MRI). During a medical imaging procedure, a medical imaging system may scan one or more portions of a patient's body, and generate a corresponding medical imaging data set.

During an imaging session associated with a single imaging modality, a patient may be subjected to multiple scans in order to enhance diagnostic accuracy and/or reduce a likelihood of diagnostic error. Successive scans may exhibit image acquisition variations, for example, differences in scan device position and/or patient orientation.

In addition to the foregoing, a patient may be subjected to imaging sessions across different timeframes and/or multiple imaging modalities in order to further enhance diagnostic accuracy and/or reduce a likelihood of diagnostic error. Thus, for any given patient, a large or very large amount of imaging data may be generated. Some or all of this imaging data may be analyzed or evaluated during a diagnostic procedure. Unfortunately, the manner in which a medical imaging system captures or acquires imaging data may not facilitate efficient and/or effective imaging data analysis in view of diagnostically useful or relevant anatomical considerations. Therefore, it can be appreciated that there is a significant need for a system and method to facilitate efficient multi-modal imaging data analysis. The present invention provides this, and other benefits as will be apparent from the following detailed description and accompanying figures.

### BRIEF DESCRIPTION OF THE DRAWINGS

FIG. 1A is a block diagram of a generalized imaging data set format according to an embodiment of the invention.

FIG. 1B is a block diagram of a generalized adjunctive data set format according to an embodiment of the invention.

FIG. 2 is a block diagram of a computing environment suitable for anatomically based processing of medical imaging information according to an embodiment of the invention.

FIG. 3 is a block diagram of a medical imaging processing platform according to an embodiment of the invention.

FIG. 4 is a flowchart of a procedure for anatomically based processing of medical imaging information according to an embodiment of the invention.

FIG. 5 is a flowchart of a positional structuring procedure according to an embodiment of the invention.

FIG. 6 is a flowchart of an anatomical structuring procedure according to an embodiment of the invention.

FIG. 7 is a flowchart of a presentation procedure according to an embodiment of the invention.

FIG. 8 is a graphical illustration of portions of an exemplary GUI according to an embodiment of the invention.

FIG. 9A is a graphical representation of a plurality of exemplary MRA imaging data sets corresponding to patient leg sections.

FIG. 9B is a graphical representation of a first and a second anatomically based MRA imaging data set generated in accordance with an embodiment of the invention.

FIG. 10A is a graphical representation of an exemplary breast imaging data set comprising complete or essentially complete imaging data spanning both breasts.

FIG. 10B is a graphical representation of an exemplary anatomically based breast imaging data set generated in accordance with an embodiment of the invention.

### DETAILED DESCRIPTION

The present disclosure describes a system and/or method for processing medical imaging information and/or generating anatomically based data sets, where the medical imaging information may correspond to one or more imaging modalities. An anatomically based data set may represent and/or correspond to an anatomical region and/or structure of interest that is defined or determined in accordance with diagnostically relevant and/or diagnostically driven criteria and/or parameters. Systems and/or methods in accordance with various embodiments of the present invention may facilitate enhanced accuracy and/or enhanced efficiency medical information analysis, for example, for patient screening and/or diagnosis procedures.

In various embodiments, imaging information may comprise or correspond to data and/or signals that have been generated, scanned, acquired, captured, recorded, received, retrieved, transferred, and/or transmitted by one or more imaging devices or systems in association with a set of imaging procedures. Imaging information may comprise, for example, pixels and/or voxels corresponding to portions of one or more images, image slices, animations, videos or movies, and/or other information.

Portions of the following description detail manners in which certain embodiments of the present invention may acquire and/or anatomically process imaging information corresponding to particular imaging modalities. Imaging information may be acquired, for example, in the context of imaging breast tissue using MRI, mammography, ultrasound, PET, Magnetic Resonance Spectroscopy (MRS) and/or other techniques. As another example, imaging information may be acquired in the context of imaging vasculature through Magnetic Resonance Angiography (MRA) techniques. Various embodiments of systems and/or methods in accordance with the present invention may facilitate anatomically based processing of information associated with essentially any set of medical imaging modalities, which may be based upon or related to one or more of MRI; functional MRI (fMRI); Magnetic Resonance Spectroscopy (MRS); Diffusion Tensor Imaging (DTI); MRA; CT; Computerized Tomographic Angiography (CTA); Medical Optical Imaging (MOI) such as Computed Optical Tomography (COT); PET; SPECT; Neutron Stimulated Emission Computed Tomography (NSECT); x-ray; dual-energy x-ray absorptiometry (DEXA); digital radiography; mammography; ductography; ultrasonography; thermography; electrical impedance tomography; magnetoencephalography (MEG); and/or one or more other imaging modalities, technologies, and/or techniques.

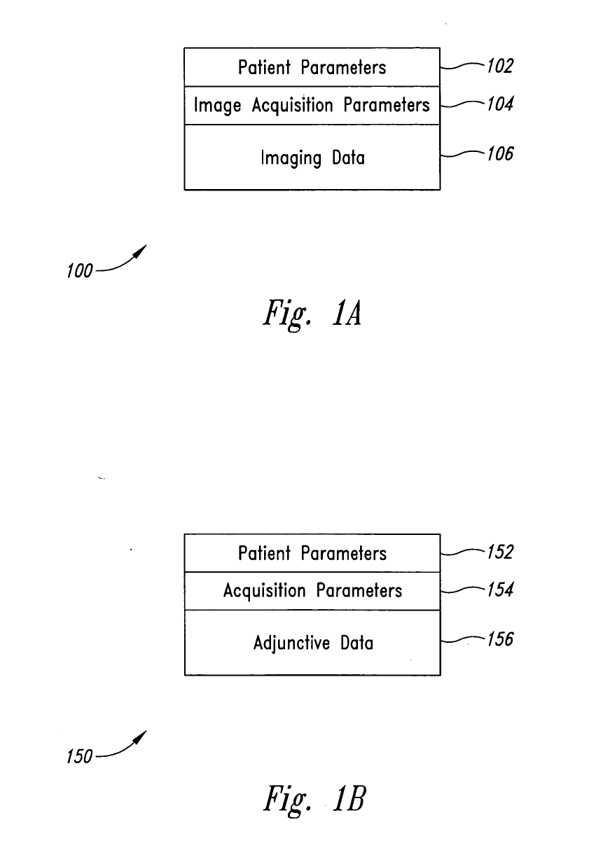

In various embodiments, imaging information may be generated, acquired, represented, encapsulated, stored, transferred, and/or exchanged in the form of one or more imaging data sets. Particular imaging data sets may at least partially conform to one or more logical and/or physical formats or standards. FIG. 1A is a block diagram of a generalized imaging data set format according to an embodiment of the invention. In one embodiment, an imaging data set format comprises a data structure 100 having a first set of fields 102 for storing or referencing patient attributes, properties, or parameters; a second set of fields 104 for storing or referencing image acquisition and/or encoding attributes, properties, or parameters; and a third set of fields 106 for storing or referencing imaging data or signals. The first and second sets of fields 102, 104 may comprise header information. Depending upon embodiment details, patient parameters may include, specify, indicate, and/or correspond to one or more patient related identifiers such, by way of example, as a patient name, patient ID, birthdate, and/or physician name. Patient information may be encrypted to conform to the statutory requirements of the Health Insurance Portability and Privacy Act (HIPAA). Image acquisition parameters may include, specify, indicate, and/or correspond to one or more of an imaging modality or imaging modality fusion; an image type; an acquisition time and/or date; a set of spatial properties such as a pixel or voxel spacing or resolution, a row count, a column count, a slice thickness, an image orientation, a patient orientation, a patient position; and/or other information. In various embodiments, imaging data sets may be generated, acquired, transferred, and/or stored in accordance with a Digital Imaging and Communications in Medicine (DICOM) standard.

In general, during a patient imaging procedure, a given type of medical imaging system or device generates an imaging data set associated with, corresponding to, and/or representing one or more patient anatomical regions and/or structures. This “as-imaged” imaging data set may span and/or correspond to additional or fewer anatomical regions than are actually of interest, primary interest, relevance, and/or primary relevance in a particular diagnostic or evaluative situation. Thus, an as-imaged imaging data set may include less relevant or even irrelevant imaging data, and/or exclude diagnostically important or relevant imaging data.

In various embodiments, an anatomically based data set comprises imaging data spanning, representing, and/or corresponding to one or more anatomical regions and/or structures of particular interest and/or relevance in a given diagnostic, analytic, or evaluative situation. An anatomically based data set may at least partially omit or exclude as-imaged imaging data spanning and/or corresponding to anatomical regions of lesser or no interest or relevance. An anatomically based data set may comprise some or possibly all of the as-imaged imaging data corresponding to one or more previously acquired, captured, and/or generated imaging data sets, as further described below. In some embodiments, a given anatomically based data set may comprise some or possibly all of the imaging data corresponding to one or more other anatomically based data sets.

An anatomically based data set may comprise imaging data spanning, representing, and/or corresponding to an anatomical region and/or structure that is anatomically subsumed by, is an anatomical subregion of, and/or is smaller or more spatially limited than an anatomical region and/or structure associated with a particular imaging data set used to generate the anatomically based data set. Alternatively or additionally, an anatomically based data set may comprise imaging data spanning, representing, and/or corresponding to an anatomical region and/or structure that anatomically subsumes, is an anatomical superregion of, and/or is larger or has a greater spatial extent than an anatomical region and/or structure associated with a particular imaging data set used to generate the anatomically based data set.

In addition to imaging information, a system and/or method in accordance with particular embodiments of the invention may process adjunctive information corresponding to one or more adjunctive modalities. Depending upon embodiment details, adjunctive information may comprise data and/or signals that have been generated, scanned, acquired, received, captured, recorded, transferred, and/or transmitted by an adjunctive information source, device, or system in association with or based upon an imaging procedure. Adjunctive information may comprise, for example, biopsy data, microscopy data, electrophysiologically based data, audio data, patient treatment history, patient monitoring and/or diary data, and/or other information.

In a manner analogous to that described above, adjunctive information may be generated, acquired, represented, encapsulated, stored, transferred, and/or exchanged as one or more adjunctive data sets, possibly in accordance with one or more logical and/or physical formats or standards. FIG. 1B is a block diagram of a generalized adjunctive data set format according to an embodiment of the invention. In one embodiment, an adjunctive data set format comprises a data structure 150 having one or more of a first set of fields 152 for storing or referencing patient attributes, properties, or parameters; a second set of fields 154 for storing or referencing adjunctive data acquisition and/or encoding attributes, properties, or parameters; and a third set of fields 156 for storing or referencing adjunctive data or signals. The first and second sets of fields 152, 154 may comprise header information. Depending upon embodiment details, adjunctive data sets may be generated, acquired, transferred, and/or stored in accordance with one or more digital data formats or standards, for example, a Graphics Interchange Format (GIF); a Joint Photographic Experts Group (JPEG) format; a bitmap (BMP) format; a Tagged Image File Format (TIFF); a Waveform (WAV) audio format; a Moving Picture Experts Group (MPEG) video and/or audio format; a DICOM or DICOM based format; a Portable Document Format (PDF); and/or another format or standard.

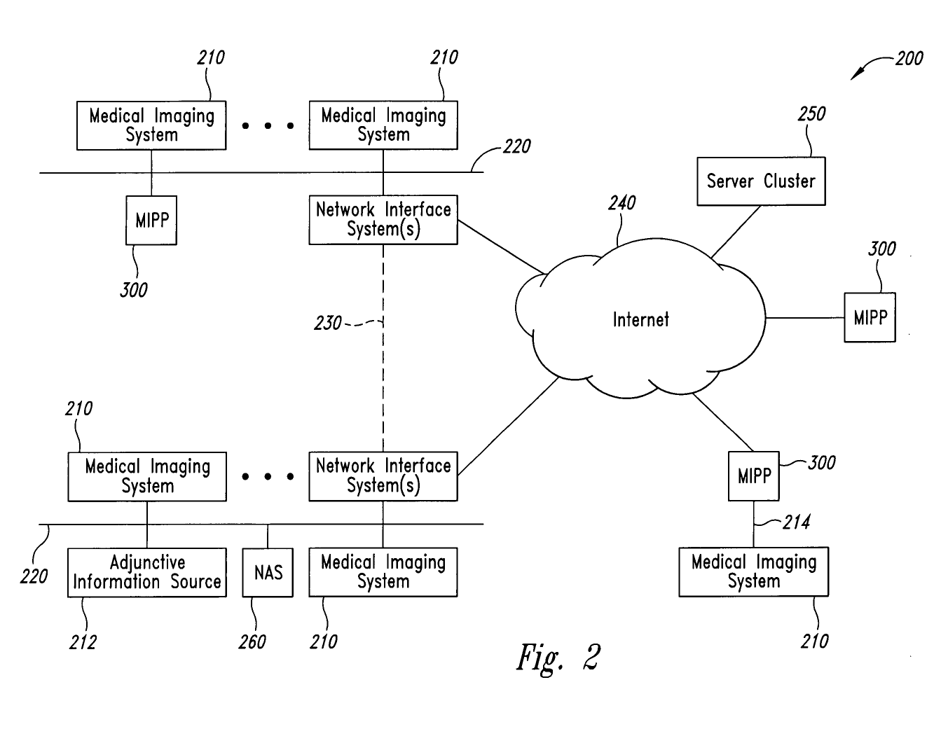

FIG. 2 is a block diagram of a computing environment 200 suitable for anatomically based processing of medical imaging information and possibly adjunctive information according to an embodiment of the invention. In one embodiment, the computing environment 200 comprises at least one medical imaging device or system 210 and at least one medical information processing platform (MIPP) 300. In certain embodiments, the computing environment 200 may additionally comprise at least one adjunctive information source 212. Any given MIPP 300 may be configured to communicate and/or exchange information with one or more medical imaging systems 210 and/or adjunctive information sources 212 in a variety of manners depending upon embodiment details. For example, in any given computing environment 200, one or more medical imaging systems 210 and/or adjunctive information sources 212 may be directly coupled to a MIPP 300 by a wire-based or wireless link 214. Additionally or alternatively, the computing environment 200 may comprise a networked architecture in which one or more medical imaging systems 210 and/or adjunctive information sources 212 are coupled to one or more MIPPs 300 by a set of computer networks. Depending upon embodiment details, the set of computer networks may comprise one or more private networks and/or public networks, which may include a local area network (LAN) 220, a wide area network (WAN) 230, and/or the Internet 240. In some embodiments, the computing environment 200 may additionally comprise one or more servers 250, server clusters, and/or network attached storage (NAS) devices and/or systems 260 configured as central or distributed medical information repositories (e.g., a Picture Archiving and Communication System (PACS)). Finally, the computing environment 200 may comprise network interface systems, devices, hardware, and/or software that facilitate user authentication, data access control, data integrity, network security, network information transfer, and/or other functions in a manner understood by those skilled in the art.

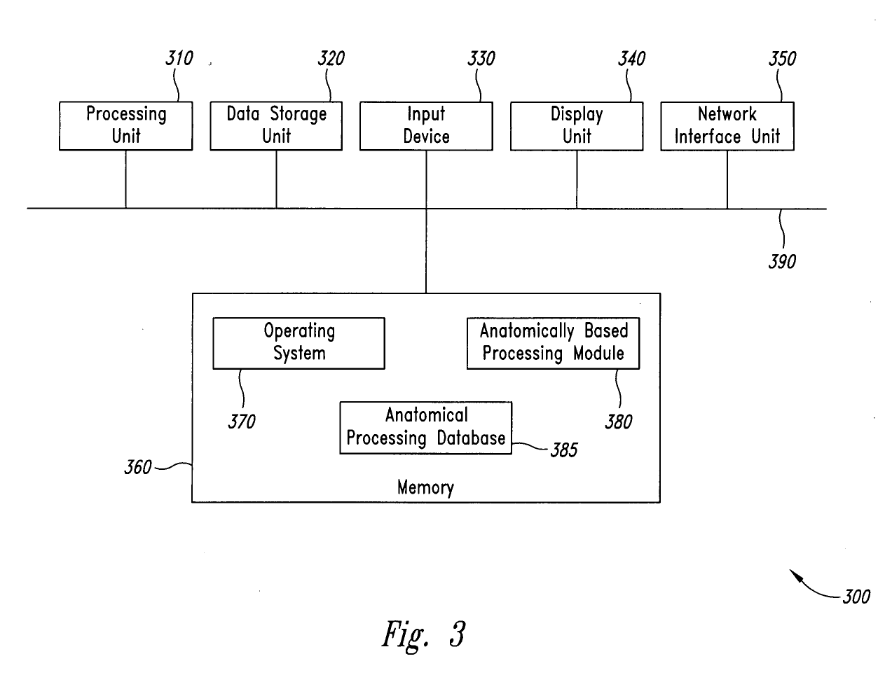

FIG. 3 is a block diagram of a medical information processing platform 300 according to an embodiment of the invention. In one embodiment, a MIPP 300 comprises a computer system that may have one or more of a processing unit 310, a data storage unit 320, an input device 330, a presentation and/or display unit 340, a network interface unit 350, and/or a memory 360. Each element of the MIPP 300 may be coupled to one or more buses 390 in a manner understood by those skilled in the art.

The processing unit 310 may comprise one or more microprocessors capable of executing stored program instructions. An input device 330 may comprise a keyboard and a pointing and/or data selection device (e.g., a mouse or trackball), in a manner understood by those skilled in the art. Those skilled in the art will further understand that the presentation unit 340 may comprise a set of display devices, for example, one or more computer monitors or electronic displays.

In general, the data storage unit 320 and/or the memory 360 may comprise one or more portions of computer readable media that store program instructions and/or data. The data storage unit 320 may comprise one or more types of fixed and/or removable hard disk, optical, and/or magneto-optical drives and/or other devices configured to receive, store, and/or transfer medical imaging information, adjunctive information, and/or other information. The memory 360 may comprise one or more types of Random Access Memory (RAM) and/or Read Only Memory (ROM).

In one embodiment, an operating system 370 and an anatomically based processing module 380 reside within the memory 360. The operating system 370 may comprise software that manages access to MIPP hardware and/or software resources, in a manner understood by those skilled in the art. In certain embodiments, portions of an anatomical processing database 385 may reside within the memory 360, the data storage unit 320, and/or another MIPP 300. The anatomical processing database 385 may store configuration settings, operational parameters, functions, procedures, and/or instruction sequences, and/or data that facilitate anatomically based processing of medical information.

At any given time, one or more portions of particular imaging data sets and/or adjunctive data sets may reside within the memory 360. In various embodiments, the anatomically based processing module 380 may comprise software that performs or manages anatomically based processing of medical information and/or operations associated therewith in accordance with particular embodiments of the invention to generate, process, present, store, and/or transfer one or more imaging data sets, anatomically structured data sets, and/or adjunctive data sets, as described in detail hereafter.

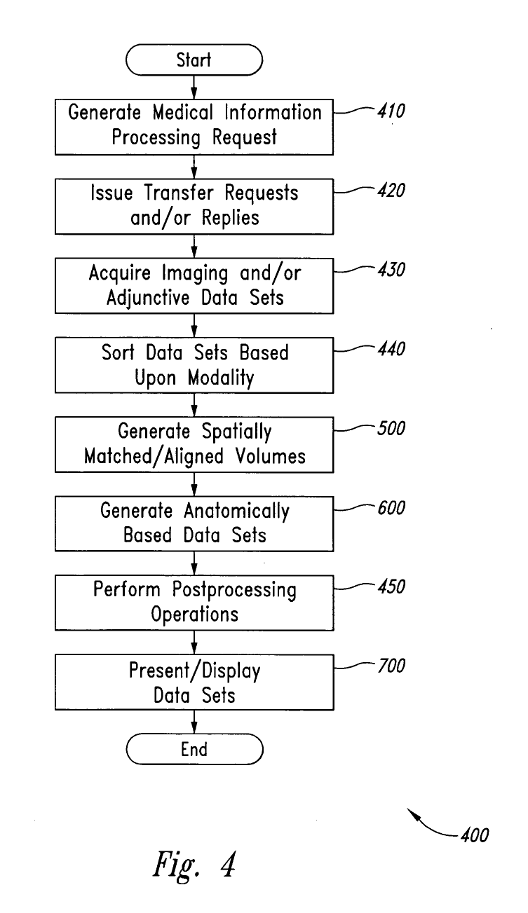

FIG. 4 is a flowchart of a procedure 400 for anatomically based processing of medical imaging information according to an embodiment of the invention. In some embodiments, the procedure 400 comprises an initialization procedure 410 that involves receiving, assembling, and/or generating a medical information processing request. A medical information processing request may include one or more patient names, physician names, date ranges, anatomical region identifiers, and/or other information that facilitate the identification, acquisition, generation, and/or presentation of medical information of interest. Depending upon embodiment details, a more detailed or specific medical information processing request may limit the scope, range, nature, modalities, and/or types of medical information considered in association with the procedure 400 to a greater extent than a more general or broader medical information processing request. In one embodiment, the initialization procedure 410 may involve receipt of user input through a Graphical User Interface (GUI).

The procedure 400 may additionally comprise a transfer setup procedure 420. In one embodiment, a transfer setup procedure 420 may involve issuing a set of information transfer requests directed toward one or more medical imaging systems 210, medical information repositories, adjunctive information sources 212, and/or MIPPs 300. An information transfer request may specify or indicate one or more setup parameters, which may comprise a set of patient names, physician names, date ranges, and/or other parameters. Setup parameters may correspond to file and/or data structure header information. Additionally or alternatively, a transfer setup procedure 404 may involve issuing a set of replies in response to transfer notifications received from one or more medical imaging systems 210, medical information repositories, adjunctive information sources 212, and/or MIPPs 300.

The procedure 400 may further comprise an acquisition procedure 430 that involves acquiring imaging information and possibly adjunctive information. Such information may be retrieved and/or received from one or more medical imaging systems 210, medical information repositories, adjunctive information sources 212, and/or MIPPs 300 at one or more times. In embodiments that include a transfer setup procedure 420, the imaging and/or adjunctive information acquired may be filtered in accordance with one or more setup parameters.

The acquired imaging information may comprise a set of imaging data sets, that is, at least one and possibly multiple imaging data sets, which may exhibit multiple types of spatial and/or temporal organizations relative to one another. For example, the imaging information may comprise one or more MRA image series, where any given MRA series may correspond to particular patient leg segments imaged upon a particular date by a given MRA system at a specific resolution in accordance with a particular patient and/or imaging orientation. In one embodiment, the acquired imaging information may additionally or alternatively comprise one or more previously generated anatomically based data sets.

In addition to the foregoing, different imaging data sets may correspond to different imaging modalities and/or modality fusions. For example, the imaging information may comprise one or more breast MR image series, one or more mammography data sets, and/or one or more ultrasound data sets (e.g., ultrasound video signals). Any given MR image series may correspond to one or both patient breasts imaged upon a particular date by a given MR system at a specific resolution in accordance with a particular patient and/or breast coil orientation to generate and/or capture a sequence of time dependent or dynamic images. In an analogous manner, any particular mammography data set may correspond to a given mammography system, a specific image resolution, a particular breast, a specific breast orientation, and/or a given patient orientation. Similar considerations may apply to ultrasound data.

The procedure 400 may further comprise a modality sorting procedure 440 that involves categorizing, sorting, and/or organizing acquired imaging data sets based upon imaging modality parameters specified or indicated within the imaging data sets; data file type (e.g., as indicated by file extension information); and/or acquisition source information. In some embodiments, the modality sorting procedure 440 may also involve categorizing, sorting, or organizing acquired adjunctive data sets in an identical, essentially identical, analogous, or related manner.

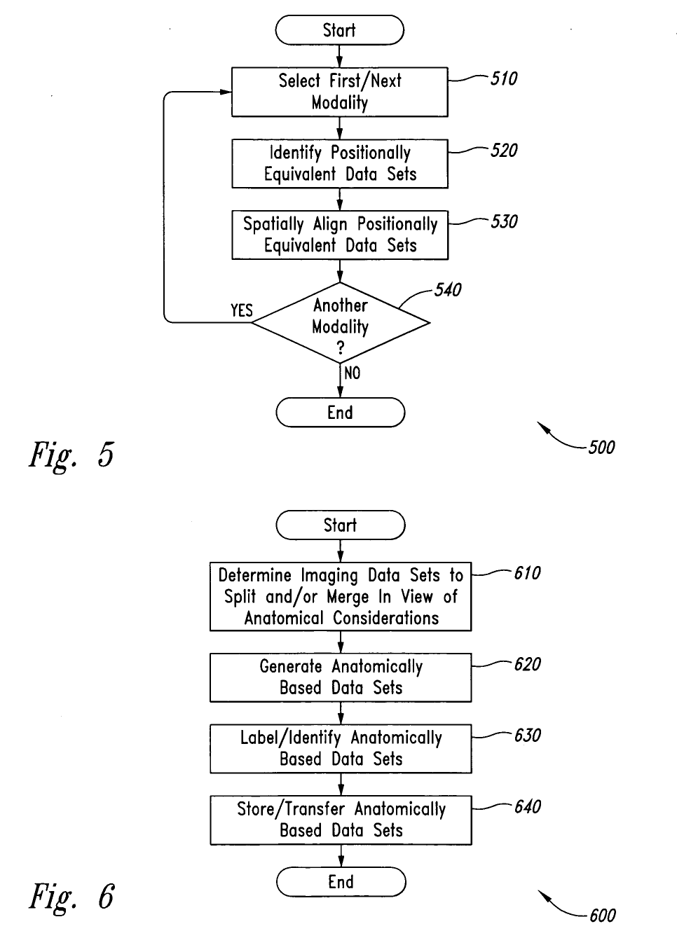

In certain embodiments, the procedure 400 may also comprise a positional structuring procedure 500 that involves associating, aligning, and/or generating imaging data sets that spatially match or correspond to each other within the scope or context of any given modality, as further described below with reference to FIG. 5. The procedure may further comprise an anatomical structuring procedure 600 that involves generating one or more anatomically based data sets in view of anatomical considerations, as further described below with reference to FIG. 6.

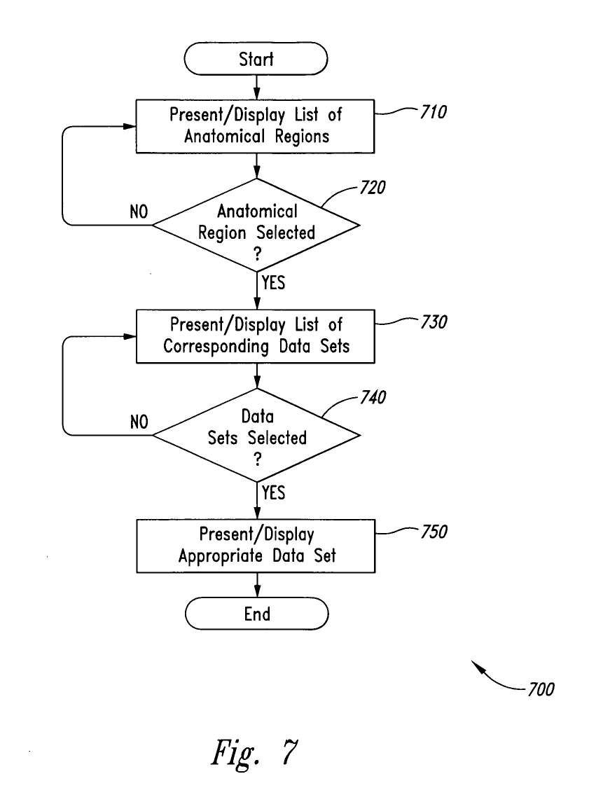

In some embodiments, the procedure 400 may additionally comprise one or more postprocessing procedures 450 that involve performing particular types of operations upon one or more anatomically structured data sets. In one embodiment, a postprocessing procedure may involve feature extraction, reconstruction, identification, analysis, classification, and/or evaluation operations to facilitate, for example, tissue characterization and/or lesion diagnosis procedures. Finally, in various embodiments, the procedure 400 may comprise a presentation procedure 700 that involves presenting and/or displaying one or more anatomically structured data sets and/or associated adjunctive data sets, as further described below with reference to FIG. 7. Depending upon embodiment details, one or more portions of the procedure 400 may be performed by a single and/or multiple MIPPs 300.

FIG. 5 is a flowchart of a positional structuring procedure 500 according to an embodiment of the invention. In one embodiment, the positional structuring procedure 500 comprises a modality selection procedure 510 that involves selecting a first or next modality for consideration. Depending upon embodiment details, the modalities available for consideration may be determined in accordance with a modality sorting procedure 440 and/or a medical information processing request.

The positional structuring procedure 500 may further comprise a positional data volume generation procedure 520 that within the scope or context of a modality currently under consideration involves associating positionally equivalent or compatible imaging data sets with each other to define a positional data volume. In certain embodiments, positional equivalence or compatibility between different imaging data sets may exist in the event that particular image acquisition parameters match or adequately correspond. In one embodiment, different imaging data sets or references thereto may be assigned to or sorted into the same positional data volume in the event that each imaging data set exhibits or corresponds to an identical pixel spacing, number of rows and columns, slice thickness, image orientation, patient orientation, and patient position.

Within some positional data volumes, imaging data sets may be sorted or ordered in accordance with increasing image position, image location, or slice location relative to a particular reference direction or axis. In one embodiment, imaging data sets having matching image acquisition parameters and an identical image position or image slice location may be assigned to or sorted into separate positional data volumes.

In certain embodiments, the procedure 500 may also comprise a spatial alignment procedure 530 that involves spatially aligning imaging data sets within a positional data volume such that any given voxel within the positional data volume corresponds to an identical physical or anatomical location. Particular imaging data sets may be padded with blank data during a spatial alignment procedure 530.

In the event that another modality requires consideration, the procedure 500 may return to the modality selection procedure 510; otherwise, the procedure 500 may end.

FIG. 6 is a flowchart of an anatomical structuring procedure 600 according to an embodiment of the invention. Depending upon embodiment details, particular portions of an anatomical structuring procedure 600 may be performed independently, or in association with portions of a positional structuring procedure 500 and/or a presentation procedure 700.

In certain embodiments, the anatomical structuring procedure 600 comprises a volume analysis procedure 610, which in one embodiment involves determining which positional data volumes include imaging data sets that may be split and/or merged to form one or more anatomically based data sets corresponding to particular anatomical regions. For example, if a positional data volume includes an imaging data set comprising MRI or PET data for both left and right breasts, the volume analysis procedure 610 may determine that this data set may be split into a left breast data set and/or a right breast data set. In various embodiments, an anatomically based data set corresponding to a single left or right breast would typically comprise fewer voxels or pixels than the imaging data set corresponding to both breasts together. Similarly, if a positional data volume includes separate imaging data sets corresponding to separate left and right breast MRI or PET data, the volume analysis procedure 610 may determine that the separate left and right breast MRI or PET data may be merged into a single data set corresponding to both breasts. In various embodiments, an anatomically based data set corresponding to both breasts together would typically comprise a greater number of voxels or pixels than either of the individual left breast or right breast data sets.

As another example, if a positional data volume includes a first imaging data set comprising MRA data corresponding to both upper legs and a second imaging data set comprising MRA data corresponding to both lower legs, the volume analysis procedure 610 may determine that portions of the first and second imaging data sets may be merged to form a first anatomically based data set corresponding to the entire left leg, and/or a second anatomically based data set corresponding to the entire right leg.

The volume analysis procedure 610 may utilize one or more anatomical region identifiers specified in a medical information processing request, and/or anatomical reference information stored within an anatomical processing database 385 to automatically and/or semiautomatically determine one or more manners in which imaging data sets under consideration may be split and/or merged. In one embodiment, the anatomical reference information may associate an anatomical region identifier with one or more rules, functions, and/or procedures that specify or indicate manners in which particular types of imaging data sets may be split and/or merged in view of anatomically relevant or useful diagnostic criteria.

Depending upon embodiment details, anatomical region identifiers may correspond to one or more of a slice location; an image orientation; an image position; a study description that specifies or indicates a body location; and/or an imaging system descriptor such as an MRI coil type. In general, the relevance of particular anatomical region identifiers may depend upon an imaging modality under consideration.

The creation of a rule, function, and/or procedure may involve the association of anatomical region identifiers with particular operations or operation sequences that may facilitate the separation of imaging data sets into a set of images corresponding to specific anatomical regions. New or updated rules, functions, and/or procedures may be created manually, semiautomatically, or automatically, possibly based upon templates and/or existing rules, functions, and/or procedures. Representative types of rules, functions, and/or procedures directed toward automatically identifying anatomical locations and splitting and/or merging imaging data sets based upon the identified anatomical locations are described hereafter.

In one representative example, if a study description is BREAST, and imaging data was acquired in a SAGITTAL orientation, a SPLIT procedure may partition the imaging data into LEFT and RIGHT data sets based upon the value of an IMAGE POSITION identifier. For example, the LEFT imaging data set may comprise imaging data for which IMAGE POSITION is less than zero; and the RIGHT imaging data set may comprise imaging data for which IMAGE POSITION is greater than or equal to zero.

In another representative example, if a study description is MRA RUNOFF and a first imaging data set has a study description of LOWER LEG, then a FIND procedure may acquire, search for, find, and/or retrieve a second corresponding imaging data set having a study description of UPPER LEG. A MERGE procedure may subsequently merge the LOWER LEG and the UPPER LEG imaging data sets, which may involve a FIND of overlapping slice locations, a DISCARD of one half of the overlapping slice locations from one imaging data set, a DISCARD of the other half of the overlapping slice locations from the other imaging data set, and a COMBINE operation to form a single anatomically based data set.

Additional and/or other rules, functions, and/or procedures may perform more complicated registration and/or segmentation operations as required. Certain embodiments may apply particular rules, functions, and/or procedures automatically, semiautomatically, or manually in response to user input.

The procedure 600 may further comprise a data set generation procedure 620 that involves splitting or dividing and/or merging portions of particular imaging data sets to generate one or more anatomically based data sets, possibly in accordance with a volume analysis procedure 610. An anatomically based data set may span, represent, and/or correspond to a different anatomical extent and/or a different number of anatomical regions and/or structures than at least one or each of the imaging data sets used to generate the anatomically based data set. Thus, an anatomical region spanning, represented by, and/or corresponding to an anatomically based data set may subsume or be subsumed by an anatomical region spanning, represented by, and/or corresponding to an imaging data set used to generate the anatomically based data set. In certain embodiments, data set splitting or dividing and/or merging may occur based upon geometric considerations. For example, one or more data set midpoints, boundaries, borders, and/or sizes with respect to a set of reference dimensions. Data set merging may additionally or alternatively involve a registration procedure, in a manner understood by those skilled in the art.

The data set generation procedure 620 may create, instantiate, copy, and/or modify the data structure 100 for storing anatomically based imaging data and corresponding header information. The header information may identify the anatomically based imaging data as unique, for example, through an anatomical region identifier and/or one or more other types of ID (e.g., a data volume ID in accordance with a DICOM standard). One or more portions of the header information may originate or be derived from header information for the source imaging data from which the anatomically based imaging data is generated.

In some embodiments, the procedure 600 may also comprise a labeling procedure 630 that involves associating a label and/or an identifier with an anatomically based data set. Depending upon embodiment details, a label may comprise one or more portions of a file name, and/or identifying and/or descriptive information (e.g., “L and R breasts,” “R leg only,” or other information) corresponding to the anatomically based data set. In one embodiment, identifying and/or descriptive information (e.g., textual, numeric, graphical, and/or iconic information) may be stored as a portion of the anatomically based data set. In one embodiment, identifying and/or descriptive information may be written into a set of data locations associated with or defined as an image border. Additionally or alternatively, identifying and/or descriptive information may be merged, integrated, and/or written into a subset of the anatomically based data set's imaging data, typically in a nonintrusive or minimally intrusive manner relative to potentially important or relevant imaging data (e.g., a textual label may be written into an anatomically based data set at a data location that maps or corresponds to a small corner region of a displayed image). One or more portions of a labeling procedure 630 may be performed in association with or as a part of a data set generation procedure 620 and/or another procedure.

In certain embodiments, the procedure 600 may additionally comprise an archival and/or transfer procedure 640 that involves storing particular anatomically based data sets upon one or more data storage units 320, and/or transferring such data sets to one or more remote locations such as a remote MIPP 300 and/or a medical information repository.

FIG. 7 is a flowchart of a presentation procedure 700 according to an embodiment of the invention. In various embodiments, the presentation procedure 700 may involve the generation of one or more graphical windows, menus, lists, and/or other types of user interface elements and/or controls in association with a GUI. The presentation procedure 700 may additionally involve the receipt and processing of graphical, textual, and/or other types of user selections or input via the input device 330.

In one embodiment, the procedure 700 comprises an anatomical region selection procedure 710 that involves the generation and/or display of a list, menu, or selection of anatomical region identifiers for which imaging data sets, anatomically based data sets, and/or adjunctive data sets corresponding to one or more anatomical regions of interest, which may be associated with a medical information processing request.

Once an anatomical region has been selected, decision 720 is YES. The procedure 700 may further comprise a data set selection procedure 730 that involves the generation and/or display of a list, menu, or selection of imaging data sets, anatomically based data sets, and/or adjunctive data sets that correspond to a selected anatomical region identifier. When a data set is selected, decision 740 is YES. Finally, the procedure 700 may comprise an output procedure 750 that involves the presentation, display, or output of a selected data set.

In various embodiments, the presentation procedure 700 may facilitate or provide for one or more types of display operations or functions, possibly in response to user input. Such display operations may comprise, for example, selection or identification of particular pixel or voxel subsets, zoom, rotation, and/or perspective variation operations, contrast and/or color adjustment, image annotation, and/or other operations.

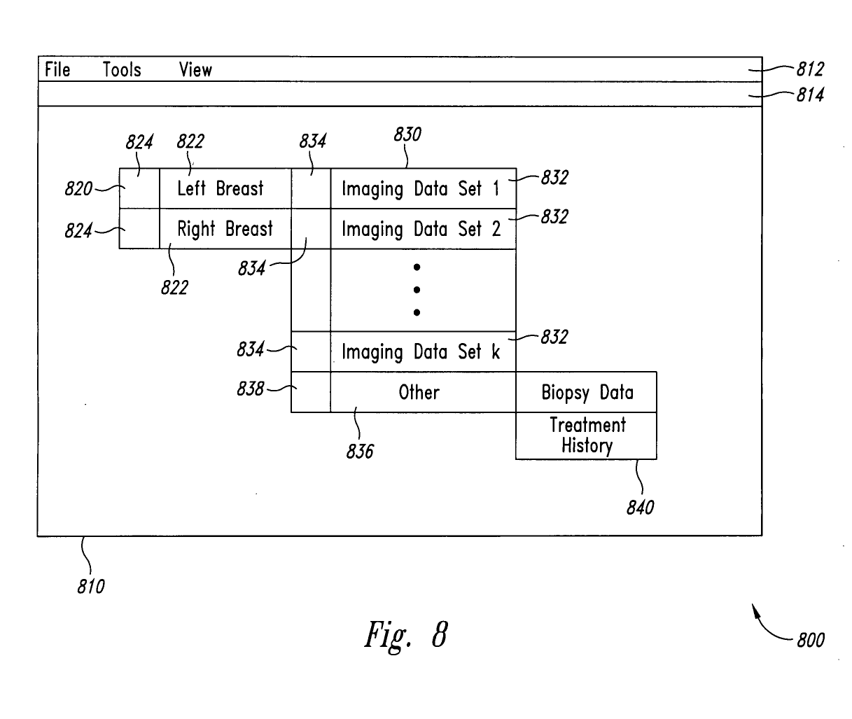

FIG. 8 is a graphical illustration of portions of an exemplary GUI 800 that may be generated in association with the presentation procedure 700 according to an embodiment of the invention. In one embodiment, the GUI 800 comprises at least one graphical window 810 within and/or upon which a set of menus 820, 830 may be displayed. For example, a first menu 820 may list, specify, and/or indicate a set of anatomical regions available for consideration, and a second menu 830 may list, specify, and/or indicate particular imaging data sets and/or anatomically based data sets corresponding to such anatomical regions. The second menu 830 may be a submenu, child menu, or hierarchical relative of the first menu 820.

In some embodiments, an item, selection, or element displayed within the first menu 820 may comprise an alphanumeric label 822 and/or a visual identifier 824 (e.g., an icon or a thumbnail image). Similarly, within the second menu 830, a displayed menu item may comprise an alphanumeric label 832 and/or a visual identifier 834. In certain embodiments, the second menu 830 may include one or more menu elements 836, 838 that correspond to adjunctive data sets. In particular embodiments, access to and/or presentation of adjunctive data sets may be facilitated through another menu 840.

The graphical window 810 may provide one or more menu bars 812, control bars 814, and/or other GUI elements in a manner understood by those skilled in the art. In other embodiments, the GUI 800 may comprise other and/or additional windows, menus, submenus, lists, and/or GUI elements.

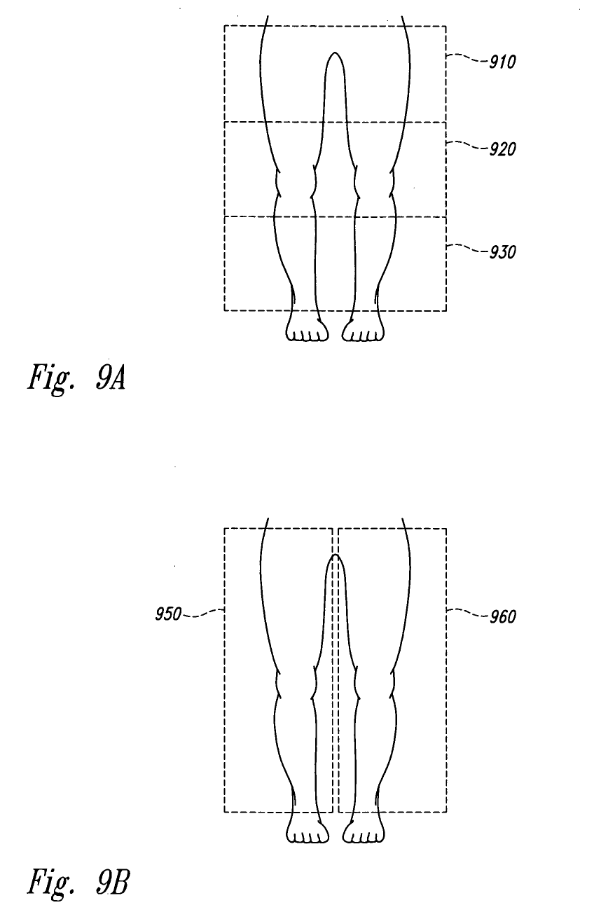

FIG. 9A is a graphical representation of a first 910, a second 920, and a third 930 exemplary MRA imaging data set. The first MRA imaging data set 910 corresponds to an upper region, section, or portion of both of a patient's left and right legs. The second MRA imaging data set 920 corresponds to a middle section of both of the patient's left and right legs; and the third MRA imaging data set 930 corresponds to a lower section of both left and right legs. Such data sets 910, 920, 930, may correspond to a manner in which imaging data sets are typically generated, for example, in a manner that is primarily defined or determined by imaging system setup, capabilities, and/or design, without specific regard for diagnostic priorities, preferences, and/or procedures.

In certain situations, the value of an MRA related diagnostic procedure may be enhanced in the event that MRA imaging information corresponding to one or more portions of a particular leg can be evaluated in a manner that is a) contiguous or generally contiguous; and b) separate from the other leg. Particular embodiments of the invention may facilitate such MRA imaging information analysis through the generation of one or more anatomically based MRA data sets.

FIG. 9B is a graphical representation of a first 950 and a second 960 anatomically based MRA data set generated in accordance with an embodiment of the invention. In one embodiment, the first anatomically based MRA data set 950 comprises contiguous or generally contiguous imaging data corresponding to the right leg, while the second MRA data set 960 comprises contiguous or generally contiguous imaging data corresponding to the left leg. As indicated in FIG. 9B, the first anatomically based MRA data set 950 corresponds to a larger contiguous or generally contiguous anatomical region (i.e., a larger right leg region in this example) than that of each of the first, second, and/or third MRA imaging data sets 910, 920, 930 considered individually. Relative to the right leg, the first anatomically based MRA data set 950 may be considered to anatomically subsume, those portions of the right leg corresponding to the first, second, and third MRA data sets 910, 920, 930. Similar considerations apply to the second anatomically based MRA data set 960.

Each of the anatomically based MRA data sets 950, 960 may facilitate enhanced efficiency and/or accuracy evaluation or analysis of the vascular characteristics of one or more portions of the leg to which it corresponds. Depending upon clinical requirements and/or embodiment details, one or both of the first and second anatomically based MRA data sets 950, 960 may be generated and/or analyzed.

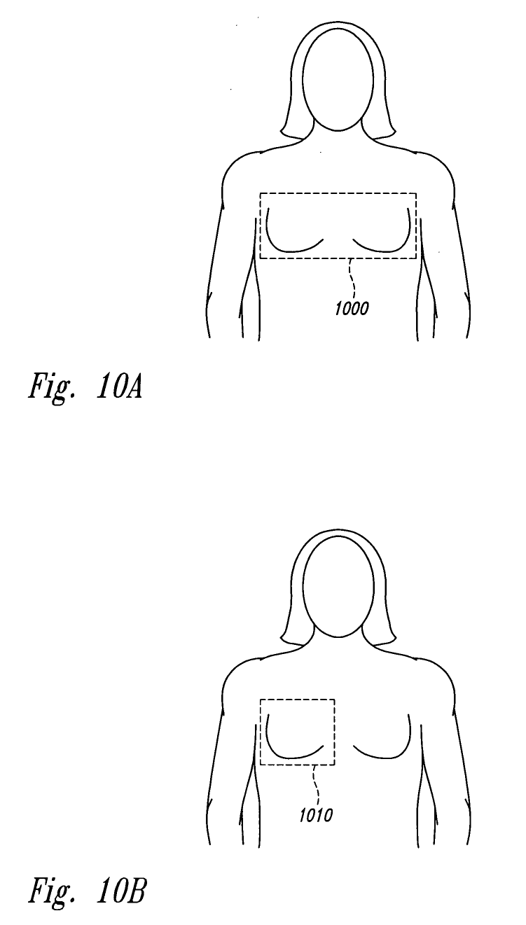

FIG. 10A is a graphical representation of an exemplary breast imaging data set 1000, which comprises complete or essentially complete imaging data spanning or generally spanning both breasts. The exemplary breast imaging data set 1000 may correspond, for example, to MRI and/or PET imaging data. FIG. 10B is a graphical representation of an exemplary anatomically based breast imaging data set 1010 generated in accordance with an embodiment of the invention. In one embodiment, the anatomically based breast imaging data set 1010 excludes unnecessary or undesired imaging data corresponding to the left breast, and thus comprises imaging data that may be relevant to evaluation or analysis of tissue within the right breast. The anatomically based breast imaging data set 1010 thus corresponds to a smaller anatomical region than the breast imaging data set 1000 used to generate the anatomically based breast imaging data set 1010. In this embodiment, the anatomically based breast imaging data set 1010 may be considered to be anatomically subsumed by the breast imaging data set 1000. Depending upon diagnostic requirements and/or embodiment details, an anatomically based breast imaging data set corresponding to the left breast may additionally or alternatively be generated. Moreover, an anatomically based breast imaging data set comprising essentially or generally complete imaging data spanning both breasts may be generated from individual (separate right and left) breast imaging source data sets (in which case such an anatomically based breast imaging data set may be considered to anatomically subsume the individual breast imaging source data sets).

From the foregoing, it will be appreciated that specific embodiments of the invention have been described herein for purposes of illustration, but that various modifications may be made without deviating from the spirit and scope of the invention. For example, various embodiments of the invention may generate anatomically based data sets corresponding to anatomical regions and/or structures other than those described above (e.g., various internal organs considered together and/or separately; and/or one or more portions of the central and/or peripheral nervous system). Accordingly, the invention is not limited except as by the appended claims.

What is claimed is:

1. A medical information processing method comprising:
acquiring a set of medical imaging data sets, each medical imaging data set comprising medical imaging information corresponding to an anatomical region; and
generating a first anatomically based data set using at least a subset of the set of the acquired medical imaging data sets, the first anatomically based data set comprising medical imaging information corresponding to one from a group comprising an anatomical subregion and an anatomical superregion of the anatomical region corresponding to at least one medical imaging data set.

2. The method of claim 1, further comprising associating a label with the first anatomically based data set.

3. The method of claim 2 wherein the label comprises a portion of a filename.

4. The method of claim 2 wherein the label corresponds to an anatomical region and comprises at least one from a group comprising textual, numeric, graphical, and iconic information stored within a portion of the anatomically based data set.

5. The method of claim 1, further comprising displaying at least a portion of an image corresponding to the first anatomically based data set.

6. The method of claim 1, further comprising generating a selection interface that facilitates selection of one from a group comprising the first anatomically based data set and an acquired medical imaging data set.

7. The method of claim 6 wherein the selection interface comprises a set of graphical menus.

8. The method of claim 7 wherein the selection interface comprises a first graphical menu organized by anatomical region.

9. The method of claim 8 wherein the selection interface comprises a second graphical menu that includes an identifier corresponding to one from a group comprising the first anatomically based data set and an acquired medical imaging data set.

10. The method of claim 1, further comprising acquiring an adjunctive data set corresponding to one from a group comprising the first anatomically based data set and an acquired medical imaging data set, the adjunctive data set comprising medically related information.

11. The method of claim 10 wherein the adjunctive data set corresponds to one from the group comprising biopsy data, a patient diagnostic history, and a patient treatment history.

12. The method of claim 10, further comprising outputting at least one from a group comprising visual signals and auditory signals corresponding to the adjunctive data set.

13. The method of claim 10, further comprising generating a selection interface that facilitates selection of the adjunctive data set.

14. The method of claim 13 wherein the selection interface comprises a graphical menu.

15. The method of claim 1 wherein the set of acquired medical imaging data sets comprises at least one medical imaging data set corresponding to a first imaging modality and at least one medical imaging data set corresponding to a second imaging modality.

16. The method of claim 15 wherein the first anatomically based data set corresponds to the first imaging modality.

17. The method of claim 16, further comprising:
displaying at least a portion of an image corresponding to the first anatomically based data set; and
displaying at least a portion of an image corresponding to an acquired medical imaging data set that corresponds to the second imaging modality.

18. The method of claim 16, further comprising generating a second anatomically based data set using at least a subset of the set of the acquired medical imaging data sets, the second anatomically based data set comprising medical imaging information corresponding to one comprising the group of an anatomical subregion and an anatomical superregion of an anatomical region corresponding to at least one medical imaging data set.

19. The method of claim 18 wherein the first and the second anatomically based data sets correspond to different anatomical regions.

20. The method of claim 18 wherein the second anatomically based data set corresponds to the second imaging modality.

21. The method of claim 20 wherein the first and the second anatomically based data sets correspond to essentially identical anatomical regions.

22. The method of claim 20 wherein the first and the second anatomically based data sets correspond to different anatomical regions.

23. The method of claim 18, further comprising associating a first label with the first anatomically based data set and a second label with the second anatomically based data set.

24. The method of claim 23 wherein at least one of the first label and the second label comprises a portion of the filename.

25. The method of claim 23 wherein at least one of the first label and the second label corresponds to an anatomical region and comprises at least one from a group comprising textual, numeric, graphical, and iconic information stored within a portion of an anatomically based data set.

26. The method of claim 18, further comprising displaying at least a portion of at least one from a group comprising an image corresponding to the first anatomically based data set and an image corresponding to the second anatomically based data set.

27. The method of claim 18, further comprising generating a selection interface that facilitates selection of one from a group comprising the first anatomically based data set and the second anatomically based data set.

28. The method of claim 27 wherein the selection interface comprises a set of graphical menus.

29. The method of claim 28 wherein the selection interface comprises a first graphical menu organized by anatomical region.

30. The method of claim 29 wherein the selection interface comprises a second graphical menu that includes an identifier corresponding to one from the group comprising the first anatomically based data set and the second anatomically based data set.

31. The method of claim 18, further comprising acquiring an adjunctive data set corresponding to one from a group comprising the first anatomically based data set and an the second anatomically based data set, the adjunctive data set comprising medically related information.

32. The method of claim 31 wherein the adjunctive data set corresponds to one from a group comprising biopsy data, a patient diagnostic history, and a patient treatment history.

33. The method of claim 31, further comprising generating at least one from a group comprising visual signals and auditory signals corresponding to the adjunctive data set.

34. The method of claim 31, further comprising generating a selection interface that facilitates selection of the adjunctive data set.

35. The method of claim 34, wherein the selection interface comprises a graphical menu.

36. A system for medical information processing comprising:
a processing unit; and
a computer readable media storing program instructions for:
acquiring medical imaging data sets, each medical imaging data set comprising medical imaging information corresponding to an anatomical region; and
generating anatomically based data sets, each anatomically based data set generated using at least a subset of the acquired medical imaging data sets, each anatomically based data set comprising medical imaging information corresponding to one from a group comprising an anatomical subregion and an anatomical superregion of an anatomical region corresponding to at least one medical imaging data set used to generate the anatomically based data set.

37. The system of claim 36 wherein the anatomically based data sets comprises a first anatomically based data set corresponding to a first anatomical region and a second anatomically based data set corresponding to a second anatomical region.

38. The system of claim 36 wherein the anatomically based data sets comprises a first anatomically based data set corresponding to a first imaging modality and a second anatomically based data set corresponding to a second imaging modality.

39. The system of claim 38 wherein the first anatomically based data set and the second anatomically based data set correspond to essentially identical anatomical regions.

40. The system of claim 38 wherein the first anatomically based data set and the second anatomically based data set correspond to different anatomical regions.

41. The system of claim 36 wherein the set of computer readable media further stores program instructions for associating a label with at least one of the anatomically based data sets.

42. The system of claim 41 wherein the label comprises a portion of a filename.

43. The system of claim 41 wherein the label corresponds to an anatomical region and comprises at least one from a group comprising textual, numeric, graphical, and iconic information stored within a portion of the at least one of the anatomically based data sets.

44. The system of claim 36, further comprising a display device, wherein the computer readable media further stores program instructions for displaying at least a portion of an image corresponding to one from a group comprising the anatomically based data sets and the acquired medical imaging data sets.

45. The system of claim 36 wherein the computer readable media further stores program instructions for generating a selection interface that facilitates selection of one from a group comprising the anatomically based data sets and the acquired medical imaging data sets.

46. The system of claim 45 wherein the selection interface comprises a set of graphical menus.

47. The system of claim 45 wherein the selection interface comprises a first graphical menu organized by anatomical region.

48. The system of claim 47 wherein the selection interface comprises a second graphical menu that includes an identifier corresponding to one from the group comprising the anatomically based data sets and the acquired medical imaging data sets.

49. The system of claim 36 wherein the computer readable media further stores program instructions for acquiring an adjunctive data set corresponding to one from the group of the anatomically based data sets and the acquired medical imaging data sets, the adjunctive data set comprising medically related information.

50. The system of claim 49 wherein the adjunctive data set corresponds to one from a group comprising biopsy data, a patient diagnostic history, and a patient treatment history.

51. The system of claim 49 wherein the computer readable media further stores program instructions for outputting at least one from a group comprising visual signals and auditory signals corresponding to the adjunctive data set.

52. The system of claim 49 wherein the computer readable media further stores program instructions for generating a selection interface that facilitates selection of the adjunctive data set.

53. The method of claim 52 wherein the selection interface comprises a graphical menu.

54. A computer readable media storing program instructions for:
acquiring a medical imaging data set, the medical imaging data set comprising medical imaging information corresponding to an anatomical region; and
generating an anatomically based data set, the anatomically based data set generated using at least a subset of the acquired medical imaging data set, the anatomically based data set comprising medical imaging information corresponding to one from a group comprising an anatomical subregion and an anatomical superregion of an anatomical region corresponding to at least a portion of the medical imaging data set used to generate the anatomically based data set.

55. The computer readable media of claim 54 wherein the anatomically based data set comprises a first anatomically based data set corresponding to a first anatomical region and a second anatomically based data set corresponding to a second anatomical region.

56. The computer readable media of claim 54 wherein the set of anatomically based data sets comprises a first anatomically based data set corresponding to a first imaging modality and a second anatomically based data set corresponding to a second imaging modality.

57. The computer readable media of claim 56 wherein the first anatomically based data set and the second anatomically based data set correspond to essentially identical anatomical regions.

58. The computer readable media of claim 57 wherein the first anatomically based data set and the second anatomically based data set correspond to different anatomical regions.

59. The computer readable media of claim 54, further storing program instructions for associating a label with the anatomically based data set.

60. The computer readable media of claim 59 wherein the label comprises a portion of a filename.

61. The computer readable media of claim 59 wherein the label corresponds to an anatomical region and comprises at least one from a group comprising textual, numeric, graphical, and iconic information stored within a portion of the anatomically based data set.

62. The computer readable media of claim 54, further storing program instructions for displaying at least a portion of an image corresponding to one from the group comprising the anatomically based data set and the acquired medical imaging data set.

63. The computer readable media of claim 54, further storing program instructions for generating a selection interface that facilitates selection of one from the group comprising the anatomically based data set and the acquired medical imaging data set.

64. The computer readable media of claim 63 wherein the selection interface comprises a set of graphical menus.

65. The computer readable media of claim 64 wherein the selection interface comprises a first graphical menu organized by anatomical region.

66. The computer readable media of claim 65 wherein the selection interface comprises a second graphical menu that includes an identifier corresponding to one from the group comprising the anatomically based data set and the acquired medical imaging data set.

67. The computer readable media of claim 36, further storing program instructions for acquiring an adjunctive data set corresponding to one from the group comprising the anatomically based data set and the acquired medical imaging data set, the adjunctive data set comprising medically related information.

68. The computer readable media of claim 67 wherein the adjunctive data set corresponds to one from a group comprising biopsy data, a patient diagnostic history, and a patient treatment history.

69. The computer readable media of claim 68, further storing program instructions for outputting at least one from a group comprising visual signals and auditory signals corresponding to the adjunctive data set.

70. The computer readable media of claim 67, further storing program instructions for generating a selection interface that facilitates selection of the adjunctive data set.

71. The computer readable media of claim 70 wherein the selection interface comprises a graphical menu.

72. A graphical user interface for facilitating processing of medical imaging information, the graphical user interface comprising:
a first menu comprising a set of anatomical region identifiers; and
a second menu comprising a set of identifiers associated with medical imaging information, the second menu hierarchically related to the first menu.

73. The graphical user interface of claim 72 wherein the medical imaging information comprises a first data set corresponding to a first imaging modality and a second data set corresponding to a second imaging modality.

74. The graphical user interface of claim 72 wherein the medical imaging information comprises an anatomically based data set generated using at least one medical imaging data set, the anatomically based data set corresponding to one from a group comprising an anatomical subregion and an anatomical superregion of an anatomical region corresponding to a medical imaging data set used to generate the anatomically based data set.

75. The graphical user interface of claim 72, further comprising a third menu comprising a set of adjunctive information identifiers, at least one adjunctive information identifier corresponding to one from the group of biopsy data, a patient diagnostic history, and a patient treatment history.
